(19) United States
(12) Patent Application Publication
(10) Pub. No.: US 2024/0177223 A1
(43) Pub. Date: May 30, 2024

(54) INFORMATION PROCESSING APPARATUS AND ORDER MANAGEMENT SYSTEM

(71) Applicant: Toshiba Tec Kabushiki Kaisha, Tokyo (JP)

(72) Inventors: Takeshi SANO, Izunokuni Shizuoka (JP); Yoshiki KURIBAYASHI, Toride Ibaraki (JP); Yuji KOJIMA, Ota Tokyo (JP); Keisuke UEDA, Fuji Shizuoka (JP); Shino NISHIKAWA, Ota Tokyo (JP)

(21) Appl. No.: 18/466,615

(22) Filed: Sep. 13, 2023

(30) Foreign Application Priority Data
Nov. 25, 2022 (JP) 2022-188709

(51) Int. Cl. G06Q 30/0601

(52) U.S. Cl. CPC G06Q 30/0635

(57) ABSTRACT

In an embodiment, an information processing apparatus includes a communication interface connectable to a mobile ordering server and a store ordering server. A control unit of the apparatus acquires, via the communication interface, first order information from the mobile ordering server. The first order information includes information about items ordered by a customer from a store via a mobile ordering application on a mobile terminal of the customer. The control unit also acquires second order information, via the communication interface, from the store ordering server of the store. The second order information includes information about items ordered by the customer from the store via an in-store ordering system of the store. The control unit can output third order information to the mobile ordering server or the mobile terminal of the customer. The third order information is obtained by combining the first order information and the second order information.

### CROSS-REFERENCE TO RELATED APPLICATION

This application is based upon and claims the benefit of priority from Japanese Patent Application No. 2022-188709, filed Nov. 25, 2022, the entire contents of which are incorporated herein by reference.

### FIELD

Embodiments described herein relate to an information processing apparatus and an order management system.

### BACKGROUND

In recent years, stores, such as restaurants, in which a customer can order a commodity by using a mobile terminal such as a smartphone or a tablet terminal are increasing. There has been proposed an order system in which a customer who visits a store can access a management control device with the customer's own mobile terminal to order a commodity.

In the related art, a commodity can be ordered in the store not only with the customer's mobile terminal but also with an order terminal operated by a store clerk or the like. The management control device in the related art can centrally manage order information from the mobile terminals and the order terminals.

However, in the related art, the management control device accessible by the customer's mobile terminal does not have a settlement function, and the customer thus cannot make a settlement in such an order system. As a result, the customer needs to pay at the store for the commodity ordered with the order system. A service called a mobile order service capable of ordering a commodity and performing settlement from the mobile terminal of the customer is also known. However, the mobile order service generally does not coordinate with the order information received from the order terminals of the store, and thus payment related to any order information from the in-store order terminals need to be performed in the store. Therefore, it is desired to construct a mechanism for improving customer convenience by enabling settlement with the mobile order service based on not only the order information from the customer's mobile terminal but also the order information from the in-store order terminals operated by the store clerk.

### BRIEF DESCRIPTION OF THE DRAWINGS

FIG. 1 is a diagram schematically showing an order system including an order management system according to an embodiment.

FIG. 2 is a block diagram of a store server.

FIG. 3 is a diagram showing a data configuration of a commodity master stored in a storage unit.

FIG. 4 is a diagram showing a data configuration of an order information management file.

FIG. 5 is a diagram showing a data configuration of a slip information management file.

FIG. 6 is a block diagram of a control unit.

FIG. 7 is a block diagram of a server device.

FIG. 8 is a diagram showing a data configuration of a store master stored in a storage unit.

FIG. 9 is a diagram showing a data configuration of a mobile order management file.

FIG. 10 is a diagram showing a data configuration of a slip information management file.

FIG. 11 is a diagram showing a data configuration of a seat information management file.

FIG. 12 is a block diagram of a control unit.

FIG. 13 is a sequence chart showing operations of an order system.

FIG. 14 is a flowchart of order reception processing by a control unit.

FIG. 15 is a flowchart of slip information change processing.

FIG. 16 is a flowchart of vacant seat notification processing.

### DETAILED DESCRIPTION

In general, according to one embodiment, an information processing apparatus and an order management system that provide improved integration of various customer ordering systems for improving customer convenience are described.

According to an embodiment, an information processing apparatus includes a communication interface connectable to a mobile ordering server and a store ordering server. A control unit of the apparatus is configured to acquire, via the communication interface, first order information from the mobile ordering server. The first order information includes information about items ordered by a customer from a store via a mobile ordering application on a mobile terminal of the customer. The control unit also acquires second order information, via the communication interface, from the store ordering server of the store. The second order information includes information about items ordered by the customer from the store via an in-store ordering system of the store. The control unit can output third order information to the mobile ordering server or the mobile terminal of the customer. The third order information is obtained by combining the first order information and the second order information.

Hereinafter, an information processing apparatus and an order management system according to certain example embodiments will be described with reference to the drawings. The present disclosure is not limited to the specific examples described below. For example, more than one mobile order server can be connected to an order management system. The order management system may be connected to a plurality of mobile order servers. In other words, the order management system may be made available to a plurality of mobile order service providers sharing the system or the like. Further, each of the mobile order server, a store server, and a server device according to the present embodiment may be implemented as a plurality of computers.

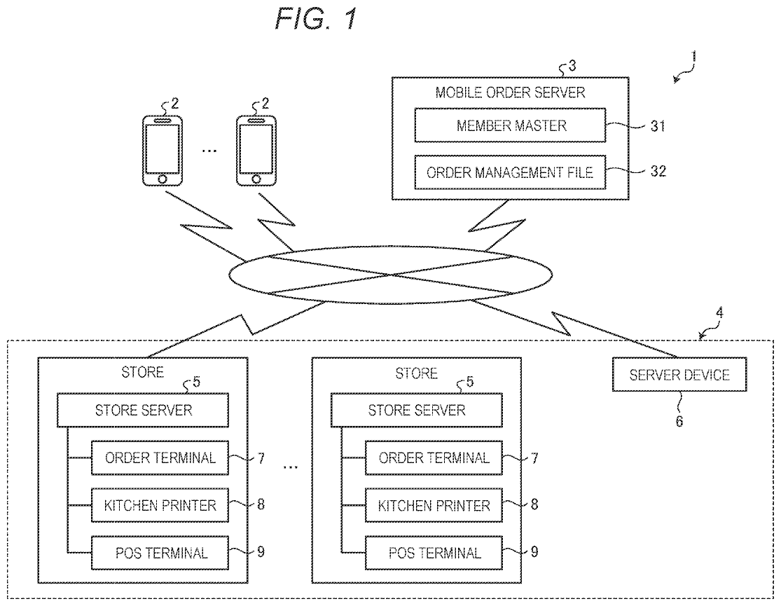

FIG. 1 is a diagram schematically showing an order system 1 providing an order management system 4. The order system 1 includes mobile terminals 2 of customers, a mobile order server 3, and an order management system 4. The mobile terminals 2, the mobile order server 3, and the order management system 4 are communicably connected to one another via a network such as the Internet.

The order system 1 incorporates a customer using a store or a restaurant, a mobile order service provider providing a mobile order service to the customer, and a cooperation service provider providing an order cooperation service for allowing the store and the mobile order service provider to cooperate (work in conjunction) with each other. The mobile order service provider receives an order from a customer for an item (commodity), sends the order for the item to a store selling the item via the cooperation service provider, and then performs the settlement (payment processing) related to the order.

The stores to which the order management system 4 can be applicable is not limited to a restaurant and, in general, may be any type of store as long as a commodity or a service can be ordered from the mobile terminal 2 of a customer and the order can be received by an order reception device of the store. For example, the store to which the order management system 4 is applied may be a store selling an apparel item where the customer orders the item with the mobile terminal 2, receives the ordered item and can then order another item. Another store type to which the order management system 4 can be applied may be a karaoke store where the customer reserves a use time (i.e., orders a service) with the mobile terminal 2 before arriving at the store and then an extension of the use time (i.e., another order of a service) can be received while the customer is in the store. In the following description, the use of the term “commodity” or “item” is to be taken as a generalized concept covering both products, menu items, and services broadly understood.

When the mobile terminal 2 can implement an ordering function and a settlement function via the mobile order server 3 by a mobile ordering application program (“application” or “mobile app”) provided in the mobile terminal 2, the order system 1 need not specifically include the mobile order server 3 in all examples. In such a case, the order management system 4 may itself transmit and receive information to and from the mobile terminal 2 and provide information as necessary to and from the mobile order server 3. The ordering function of the mobile order server 3 is, for example, a function of transmitting order information to a store via a server device 6. The settlement function of the mobile order server 3 is a function of communicating with a settlement server (payment processing server) of a settlement provider to complete settlement of transactions related to the order information.

In some examples, the mobile order service provider and the cooperation service provider may be the same provider. In this case, the mobile order server 3 and the server device 6 are managed by the same provider.

The mobile terminal 2 is an information processing terminal owned by the customer who uses the mobile order service and can be a smartphone, a tablet terminal, or the like. The mobile terminal 2 transmits and receives information to and from the mobile order server 3. The mobile terminal 2 may transmit and receive the information to and from the mobile order server 3 by a function of the mobile ordering application or may transmit and receive the information to and from the mobile order server 3 by accessing a website by using a browser. The customer can order a commodity by using the mobile terminal 2. Accordingly, the customer who visits a store can order a commodity even if a store clerk (wait staff) does not come to a table where the customer is seated. Therefore, even when the store is crowded or the number of store clerks is small, the customer can order a commodity quickly and without interaction with the wait staff or the like.

The mobile order server 3 is managed by the mobile order service provider. The mobile order server 3 includes a storage unit that stores a member master 31 and an order management file 32. The storage unit also stores various types of other information. The member master 31 is a master file storing member information for the mobile order service. In the member master 31, a member ID for specifying a member, a name of the member, a notification destination (an e-mail address, a telephone number, or the like), settlement information, and the like are registered in association with one another. The settlement information is account information (e.g., a credit card number) necessary for the settlement provider to perform the settlement.

The order management file 32 is a file in which the order information received from the mobile terminal 2 of a member of the mobile order service is stored in association with the member ID. The order information received by the mobile order server 3 includes the member ID, a store ID for specifying the store visited by the customer, a table number for specifying the table where the customer is seated, a commodity ID for specifying an ordered commodity, and the like.

The mobile order server 3 stores the order information received from the mobile terminal 2 in the order management file 32 and manages the stored order information. The order information received by the mobile order server 3 is transmitted to a store server 5 via the server device 6. The store server 5 is a store server managed by the store that sells the ordered commodity. When receiving a settlement request from the mobile terminal 2, the mobile order server 3 transmits and receives information to and from a settlement server of the settlement provider to complete the settlement related to the order of the member.

The order management system 4 includes the store servers 5 managed by the stores selling commodities and a server device 6 managed by the cooperation service provider. The store server 5 and the server device 6 are communicably connected to each other via a network such as the Internet.

The store server 5 manages various types of information for the store. The store server 5 is connected to an order terminal 7, a kitchen printer 8, and a point of sales (POS) terminal 9 via a network such as a local area network (LAN) in the store.

The order terminal 7 is, for example, an information device carried by the store clerk, and receives order information from a customer by an input operation of the store clerk. The order information received by the order terminal 7 generally includes the table number, the commodity ID for specifying the ordered commodity, and the like. The order terminal 7 is an example of an order reception device of a store.

The kitchen printer 8 is provided in a kitchen (cooking room). The kitchen printer dispenses a slip (order slip) on which the information indicating the ordered commodity is printed. A person in charge of cooking then cooks or otherwise prepares the ordered commodity as printed on the dispensed slip.

The POS terminal 9 executes checkout processing for the ordered commodity. The checkout processing is processing by which the customer pays a purchase price. At the POS terminal 9, the customer can pay for a part or all of orders from the mobile order service as well as orders made via the store clerk. Alternatively, the customer can make a settlement via the mobile order service using the mobile terminal 2 for some or all of the orders from the mobile order service as well as the order made via the store clerk. The order terminal 7, the kitchen printer 8, and the POS terminal 9 are widely known devices in the related art.

The store server 5 acquires the order information input via the mobile terminal 2 from the server device 6. Hereinafter, orders made via the mobile terminal 2 are also referred to as “first order information.” The first order information includes the member ID of the mobile order service, the store ID, the table number, and the commodity ID of the ordered commodity. The store server 5 also acquires order information input to the order terminal 7 from the order terminal 7. Hereinafter, orders input via the order terminal 7 are also referred to as “second order information.” The second order information includes the table number and the commodity ID of the ordered commodity. In the following description, when the first order information and the second order information are not being particularly distinguished from each other, the first order information and the second order information may both be simply referred to as “order information.”

The server device 6 acquires the first order information from the mobile order server 3. The server device 6 outputs the first order information to the store server 5 of the store specified by the store ID included in the first order information.

The server device 6 acquires the order information received by the store from the store server 5. Specifically, the server device 6 acquires slip information including the order information received by the store from the store server 5. The order information received by the store can be the first order information or the second order information. In other words, the server device 6 acquires, from the store server 5, the first order information input via the mobile terminal 2 by the customer who visits the store and the second order information input to the order terminal 7 by the store clerk. The server device 6 acquires the first order information and the second order information by acquiring the slip information including third order information obtained by associating and integrating the first order information and the second order information for the same customer in the store server 5.

The association between the first order information and the second order information can be performed by the customer providing information identifying the customer in both the first order information and the second order information. In the present embodiment, the table number of the table where the customer is seated is used as the linking customer identifying information, but the customer identifying information is not limited thereto. The customer identifying information may be the customer's member ID for the mobile order service. In this case, the member ID is conveyed to the store clerk when the customer gives an order, and the store clerk inputs the member ID to the order terminal 7. Accordingly, the provided member ID can also be included in the second order information.

The server device 6 outputs the third order information to the mobile order server 3. When the application of the mobile terminal 2 has the ordering function and the settlement function of the mobile order server 3, the server device 6 outputs the third order information to the mobile terminal 2. By the server device 6 transmitting the third order information to the mobile order server 3 or the mobile terminal 2, the second order information received by the order terminal 7 can also be coordinated with the mobile order service. Therefore, the customer can confirm the order information and perform the settlement related to the combined order information by using the mobile terminal 2 for settling of the second order information as well. The server device 6 is an example of an information processing apparatus.

In the present embodiment, the association between the first order information and the second order information of the same customer is performed by the store server 5, but the association may be performed by the server device 6. In this case, the server device 6 can acquire just the second order information from the store server 5 and associate the second order information with the first order information acquired from the mobile order server 3.

The number of mobile terminals 2, mobile order server 3, store servers 5, server devices 6, order terminals 7, kitchen printers 8, and POS terminals 9 are not limited to the example shown in the figure.

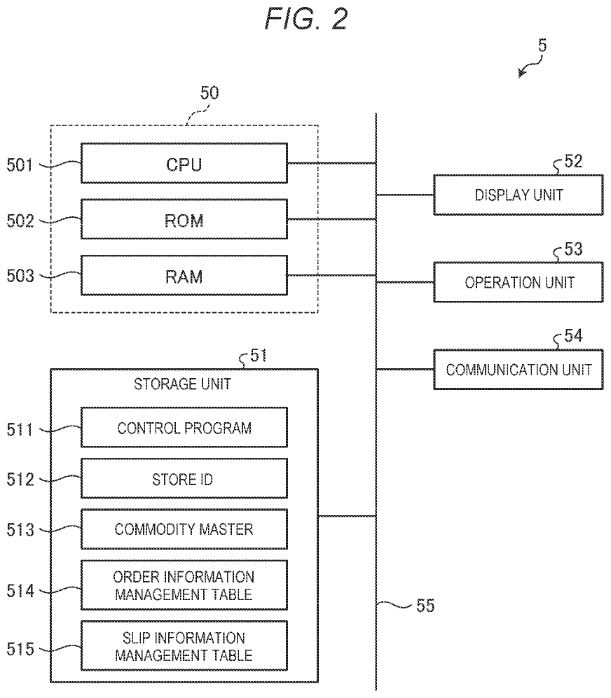

FIG. 2 is a block diagram showing a hardware configuration of the store server 5. The store server 5 includes a control unit 50, a storage unit 51, a display unit 52, an operation unit 53, and a communication unit 54. The control unit 50, the storage unit 51, the display unit 52, the operation unit 53, and the communication unit 54 are connected to one another via a bus 55.

The control unit 50 includes a central processing unit (CPU) 501, a read only memory (ROM) 502, and a random access memory (RAM) 503. The CPU 501, the ROM 502, and the RAM 503 are connected to one another via the bus 55.

The CPU 501 controls an overall operation of the store server 5. The ROM 502 stores various pieces of data and various programs such as programs used for driving the CPU 501. The RAM 503 is used as a work area of the CPU 501, and loads various programs and various pieces of data stored in the ROM 502 and the storage unit 51. The control unit 50 executes various types of control processing of the store server 5 by the CPU 501 operating according to a control program stored in the ROM 502 and the storage unit 51 and loaded in the RAM 503.

The storage unit 51 is implemented as a storage medium such as a hard disk drive (HDD) or a flash memory, and maintains stored contents even when power is turned off. The storage unit 51 stores a control program 511, a store ID 512, a commodity master 513, an order information management table 514, and a slip information management table 515.

The control program 511 is a program for providing a function of transmitting and receiving various types of information to and from the server device 6, a function of acquiring the second order information from the order terminal 7, a function of associating the first order information received from the server device 6 with the second order information acquired from the order terminal 7 for each customer, and the like.

The store ID is information for specifying a host store. The store ID is given by, for example, the mobile order service provider. The store ID is an example of store specifying information.

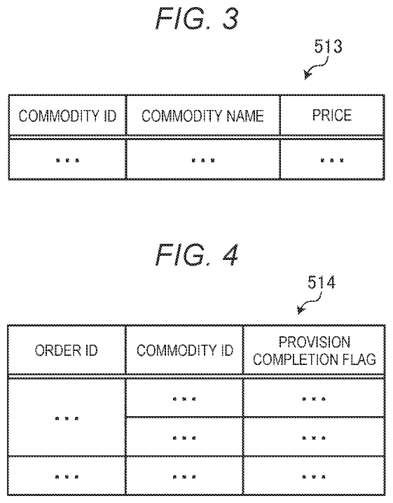

The commodity master 513 is a master file for managing commodity information about commodities (items) sold in the store. The commodity master 513 can be said to be a file for managing a menu of the commodity provided to the customer by the store. FIG. 3 is a diagram showing a data configuration of the commodity master 513. The commodity master 513 stores a commodity name and a price in association with the commodity ID.

The commodity ID is information for specifying the commodity that has been ordered. The commodity ID is an example of commodity specifying information. For example, the commodity ID may be a menu number or the like. The commodity name is information indicating the name of the commodity. The price is information indicating the price of the commodity. The commodity master 513 may store other commodity information such as a commodity image (a representative picture of the item).

The order information management table 514 is a data table for managing whether an ordered commodity has been provided to the customer. FIG. 4 is a diagram showing a data configuration of the order information management table 514. The order information management table 514 stores an order ID, the commodity ID, and a provision completion flag in association with one another.

The order ID is information for specifying the order. For example, the order ID of the first order information is dispensed by the mobile order server 3, and the order ID of the second order information is dispensed by the store server 5. The commodity ID is the information for specifying the commodity as described above. When a plurality of commodities are ordered in one order, a plurality of commodity IDs are registered in association with the order ID.

The provision completion flag is information indicating whether the ordered commodity is provided to the customer. When the ordered commodity is not provided to the customer, “0” is registered in the provision completion flag, and when the ordered commodity is provided to the customer, “1” is registered in the provision completion flag. The provision completion flag is registered in association with each commodity ID. The provision completion flag is updated based on, for example, provision completion information from the order terminal 7 or a terminal device provided in the kitchen.

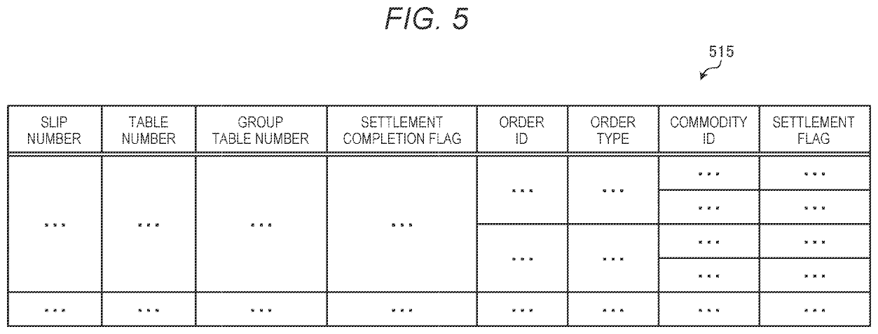

The slip information management table 515 is a data table for managing the slip information of the customer. The slip information (combined order ticket) is information for all orders of one customer. Here, “one customer” may comprise a group of people who perform settlement with the same checkout processing (e.g., “on the same check”), and is thus not necessarily a single person. The slip information management table 515 can be said to be a data table for managing the third order information that is obtained by integrating the first order information and the second order information for each customer. FIG. 5 is a diagram showing a data configuration of the slip information management table 515. The slip information management table 515 stores a slip number, the table number, a group table number, a settlement completion flag, the order ID, an order type, the commodity ID, and a settlement flag in association with one another.

The slip number is information for uniquely specifying the slip information. In other words, the slip number is information for linking all orders of one customer in one visit. The slip number is dispensed, for example, when an order is first received from the customer. The table number is information for specifying the table where the customer is seated. The table number is an example of the customer specifying information. When “one customer” uses or occupies a plurality of tables, the table number of any one of the tables can be registered.

The group table number is information for specifying a table where a particular person corresponding to the “one customer” of the corresponding table number is seated. The group table number is registered when “one customer” uses a plurality of tables. The group table number is registered and set, for example, based on information received from the order terminal 7 from a store clerk. The settlement completion flag is information indicating whether the settlement has been completed for all orders of the customer specified by the slip number. When the settlement for a part or all of the orders of the customer specified by the slip number is not yet completed, “0” is registered in the settlement completion flag, and when the settlement for all of the orders is completed, “1” is registered in the settlement completion flag.

The order ID is the information for specifying a particular order as described above. When the customer who visits the store orders many times in the same visit, a plurality of order IDs may be registered in association with the slip number. The order type is information indicating whether the specific order was an order based on the mobile order service or an order received by the store clerk. In other words, the order type is information indicating whether the order information is the first order information or the second order information.

The commodity ID is information for specifying a commodity. When a plurality of commodities are ordered in one order, a plurality of commodity IDs are registered in association with the order ID. The settlement flag is information indicating whether the settlement of the commodity of the corresponding commodity ID is completed. When the settlement is not yet completed for the commodity specified by the commodity ID, “0” is registered in the settlement flag, and when the settlement is completed, “1” is registered in the settlement flag. In the present embodiment, the customer can pay for each commodity separately if desired. For example, the customer can first pay for some of the ordered commodities, such as when a part of a group of customers leaves the store first before others, settlement for the orders associated with the leaving group can be made at that time. Accordingly, convenience for the customers can be improved when handling splitting groups.

It is also possible to determine that the settlement is completed for all the orders specified by the slip number after all the settlement flags corresponding to one slip number are updated to “1”. Accordingly, the slip information management table 515 may not necessarily include an item of the settlement completion flag.

Returning to FIG. 2, the hardware configuration of the store server 5 will be described.

The display unit 52 is implemented as, for example, a liquid crystal panel, and displays various types of information. The display unit 52 displays information stored in, for example, the commodity master 513, the order information management table 514, and the slip information management table 515 as necessary.

The operation unit 53 is used for inputting information to the control unit 50, and includes a keyboard, a touch panel, a mouse, and the like.

The communication unit 54 is an interface for communicating with an external device such as the server device 6, the order terminal 7, the kitchen printer 8, and the POS terminal 9. The control unit 50 can transmit and receive information (data) to and from the external device by being connected to the external device via the communication unit 54.

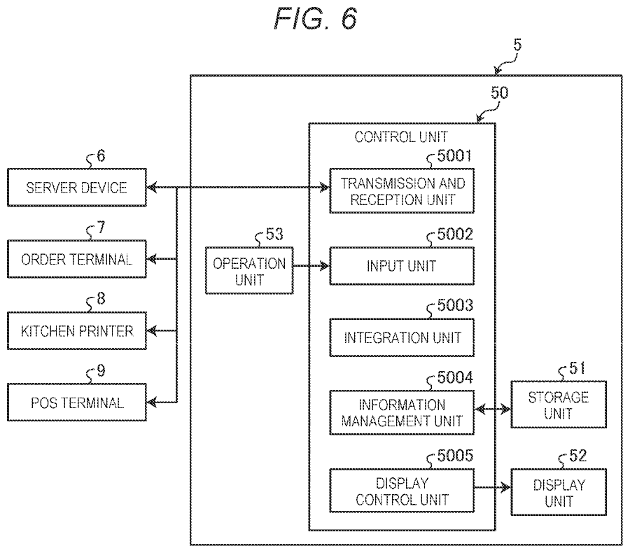

Next, a functional configuration of the store server 5 will be described. FIG. 6 is a block diagram showing a functional configuration of the control unit 50 of the store server 5. The control unit 50 functions as a transmission and reception unit 5001, an input unit 5002, an integration unit 5003, an information management unit 5004, and a display control unit 5005 by the CPU 501 operating according to the control program stored in the ROM 502 and the storage unit 51. Each function may be implemented as hardware such as a dedicated circuit.

The transmission and reception unit 5001 transmits and receives various types of information to and from the server device 6, the order terminal 7, the kitchen printer 8, and the POS terminal 9. For example, the transmission and reception unit 5001 periodically transmits an order information request for requesting the first order information to the server device 6 at a short time interval, and receives the first order information from the server device 6 as a response. Accordingly, the store server 5 can substantially continuously receive the first order information. Further, the transmission and reception unit 5001 receives the second order information from the order terminal 7. The transmission and reception unit 5001 functions as a first acquisition unit that acquires the first order information and a second acquisition unit that acquires the second order information in the order management system 4. Further, the transmission and reception unit 5001 outputs the third order information obtained by integrating the first order information and the second order information of the same customer to the server device 6.

The transmission and reception unit 5001 receives table change information input to the order terminal 7 by the store clerk from the order terminal 7 when the customer moves to another table. The table change information includes a table number before a customer move and a table number after the move. The table number is an example of seat specifying information for specifying a seat or position of the customer. The transmission and reception unit 5001 is an example of a seat information acquisition unit that acquires seat information.

The transmission and reception unit 5001 outputs a cooking instruction to the kitchen printer 8. The cooking instruction is information for instructing the person in charge of cooking to cook or otherwise prepare the commodity specified by the commodity ID included in the first order information or the second order information received by the transmission and reception unit 5001. The transmission and reception unit 5001 also receives settlement information from the POS terminal 9. The settlement information is information indicating that the customer completes the payment of the ordered commodity. The transmission and reception unit 5001 functions as a settlement information acquisition unit that acquires the settlement information.

Various types of information are input to the input unit 5002 from the operation unit 53. For example, information for updating the commodity master 513 is input to the input unit 5002.

The integration unit 5003 integrates a plurality of pieces of order information of the same customer that has been received by the transmission and reception unit 5001. For example, the integration unit 5003 integrates the first order information and the second order information of the same customer. Specifically, in this example, the integration unit 5003 integrates the plurality of pieces of order information by using the table number included in the order information as a key. More specifically, when the transmission and reception unit 5001 receives the order information, the integration unit 5003 refers to the slip information management table 515 and determines whether the table number included in the order information received by the transmission and reception unit 5001 is registered. If the table number is registered in the slip information management table 515, the registered order information and the received order information are registered in the slip information management table 515 in association with each other. When the first order information and the second order information are associated with one slip number in the slip information management table 515, the slip information for the slip number is an example of the third order information obtained by integrating the first order information and the second order information of the same customer.

The information management unit 5004 manages various types of information such as the information received by the transmission and reception unit 5001. Here, the management of the information means writing or reading the various types of information (data) into or from the storage unit 51.

For example, the information management unit 5004 writes necessary information into the order information management table 514 based on the order information received by the transmission and reception unit 5001. Specifically, the information management unit 5004 writes the order ID and the commodity ID included in the first order information as received by the transmission and reception unit 5001 into the order information management table 514 in association with each other. When the transmission and reception unit 5001 receives the second order information, the information management unit 5004 dispenses the order ID for the second order information. Further, the information management unit 5004 writes the dispensed order ID and the commodity ID included in the second order information into the order information management table 514 in association with each other. At this time, the information management unit 5004 writes “0” to the corresponding provision completion flag.

The information management unit 5004 updates the provision completion flag of the order information management table 514 based on the provision completion information received by the transmission and reception unit 5001 from the order terminal 7 or the terminal device provided in the kitchen. Specifically, the information management unit 5004 rewrites the provision completion flag corresponding to the commodity ID included in the provision completion information received by the transmission and reception unit 5001 to “1”.

The information management unit 5004 writes necessary information into the slip information management table 515 based on the order information received by the transmission and reception unit 5001. Specifically, the information management unit 5004 reads, from the slip information management table 515, the slip number for which the table number included in the order information received by the transmission and reception unit 5001 is registered. Then, the information management unit 5004 writes information (the order ID, the order type, and the commodity ID) from the order information received by the transmission and reception unit 5001 in association with the slip number.

If the table number included in the order information is not registered in the slip information management table 515, the information management unit 5004 newly dispenses a new slip number. Then, the information management unit 5004 writes the newly dispensed slip number and the information for the order information into the slip information management table 515 in association with each other. That is, when the order information received by the transmission and reception unit 5001 relates to a first order of the customer, the information management unit 5004 newly dispenses the slip number and writes the slip number and the information regarding the order information into the slip information management table 515 in association with each other.

The information management unit 5004 writes necessary information into the slip information management table 515 based on the settlement information received by the transmission and reception unit 5001. Specifically, the commodity ID corresponding to the table number and the commodity ID included in the settlement information received by the transmission and reception unit 5001 is read from the slip information management table 515. Then, the information management unit 5004 rewrites the settlement flag corresponding to the read commodity ID to “1”. When the settlement flags of all the commodity IDs corresponding to the slip number are rewritten to “1”, the information management unit 5004 rewrites the settlement completion flag corresponding to the slip number to “1”.

The display control unit 5005 displays the various types of information on the display unit 52. For example, the display control unit 5005 displays the information stored in the commodity master 513, the order information management table 514, and the slip information management table 515 on the display unit 52 as necessary.

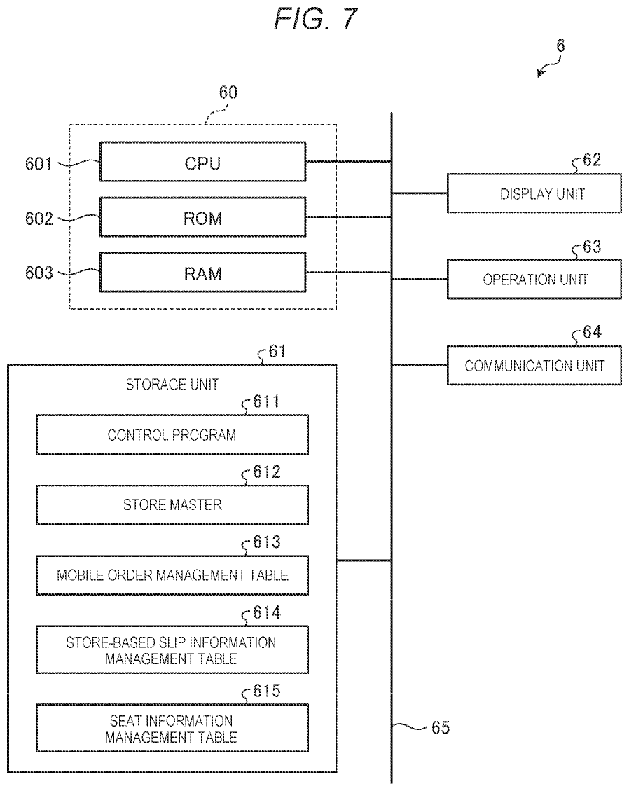

FIG. 7 is a block diagram showing a hardware configuration of the server device 6. The server device 6 includes a control unit 60, a storage unit 61, a display unit 62, an operation unit 63, and a communication unit 64. The control unit 60, the storage unit 61, the display unit 62, the operation unit 63, and the communication unit 64 are connected to one another via a bus 65.

The control unit 60 includes a CPU 601, a ROM 602, and a RAM 603. The CPU 601, the ROM 602, and the RAM 603 are connected to one another via the bus 65.

The CPU 601 controls an overall operation of the server device 6. The ROM 602 stores various types of data and various programs such as programs used for driving the CPU 601. The RAM 603 is used as a work area of the CPU 601, and loads the various programs and the various types of data stored in the ROM 602 and the storage unit 61. The control unit 60 executes various types of control processing of the server device 6 by the CPU 601 operating according to a control program stored in the ROM 602 and the storage unit 61 and loaded in the RAM 603.

The storage unit 61 is implemented as a storage medium such as an HDD or a flash memory, and maintains stored contents even when the power is turned off. The storage unit 61 stores a control program 611, a store master 612, a mobile order management table 613, a store-based slip information management table 614, and a seat information management table 615.

The control program 611 is a program for providing a function of transmitting and receiving various types of information to and from the mobile order server 3 and the store server 5, a function of managing the slip information received from the store server 5 for each customer, and the like.

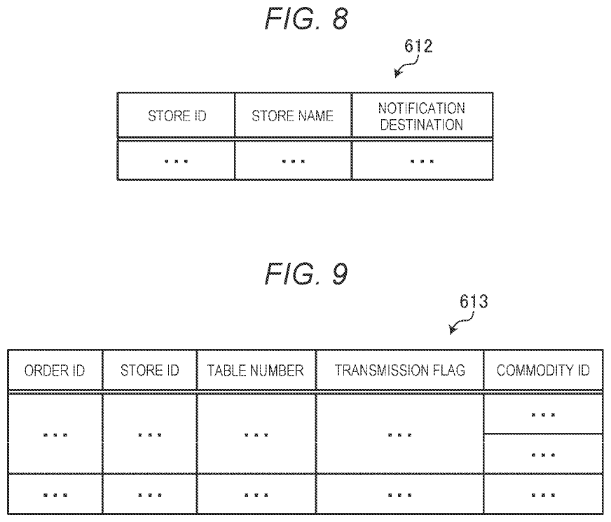

The store master 612 is a master file for managing information about a store that uses the mobile order service. FIG. 8 is a diagram showing a data configuration of the store master 612. The store master 612 stores a store name and a notification destination in association with the store ID.

The store ID is the information for specifying a store. The store name is information indicating the name of the store. The notification destination is information indicating a notification destination for the store such as a communication address for the store server 5, a telephone number of the store, and the like.

The mobile order management table 613 is a data table for managing whether the first order information received from the mobile order server 3 has been transmitted to the store that sells the ordered commodity. FIG. 9 is a diagram showing a data configuration of the mobile order management table 613. The mobile order management table 613 stores the order ID, the store ID, the table number, a transmission flag, and the commodity ID in association with one another.

The order ID is the information for specifying the order. The store ID is the information indicating the store that sells the commodity ordered by the customer, in other words, the store visited by the customer. The table number is the information for specifying the table where the ordering customer is seated. The order ID, the store ID, and the table number are registered based on the order information received from the mobile order server 3.

The transmission flag is information indicating whether the order information specified by the corresponding order ID has been transmitted to the store server 5. When the order information of the corresponding order ID is not yet transmitted to the store server 5, “0” is registered in the transmission flag, and when the order information has been transmitted to the store server 5, the transmission flag is rewritten to “1”. The commodity ID is the information for specifying the ordered commodity as described above. When a plurality of commodities are ordered in one order, a plurality of commodity IDs are registered in association with the order ID.

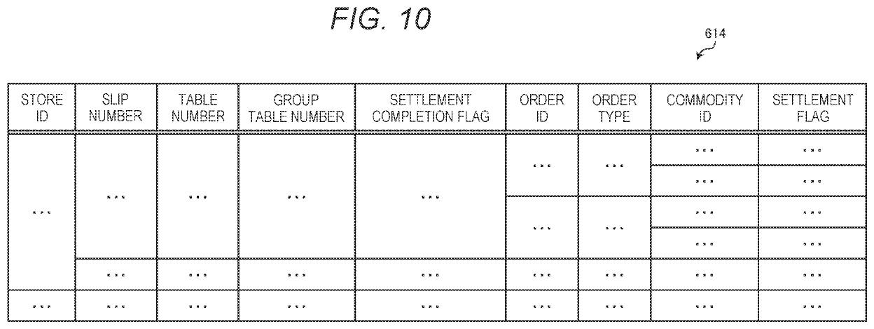

The store-based slip information management table 614 is a data table for managing the slip information that has been received from the store server 5 of each store. In other words, the store-based slip information management table 614 is a data table for managing the slip information for all stores though on an individual store basis. FIG. 10 is a diagram showing a data configuration of the store-based slip information management table 614. The store-based slip information management table 614 stores the slip information acquired from the store server 5 in association with the corresponding store ID. Specifically, the store-based slip information management table 614 stores the slip number, the table number, the group table number, the settlement completion flag, the order ID, the order type, the commodity ID, and the settlement flag in association with the store ID. The store-based slip information management table 614 manages the slip information including the first order information and the second order information, and the registered order ID includes the order ID of the first order information and the order ID of the second order information.

The store ID is the information for specifying the store as described above. The slip number, the table number, the group table number, the settlement completion flag, the order ID, the order type, the commodity ID, and the settlement flag are the same as in the description of the slip information management table 515 stored in the store server 5, and thus redundant description is omitted here.

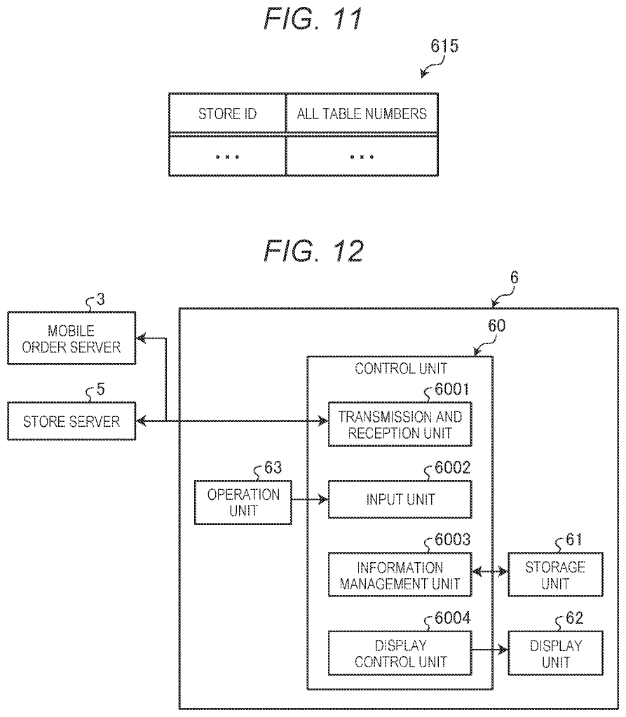

The seat information management table 615 is a data table for managing the table numbers of tables provided in each store. The seat information management table 615 is updated based on the information acquired from each store. FIG. 11 is a diagram showing a data configuration of the seat information management table 615. The seat information management table 615 stores the store ID and all the corresponding table numbers in association with each other.

The store ID is the information for specifying the store as described above. The table numbers are information indicating all table numbers of the store as specified by the corresponding store ID. For example, for a store with a table number 1 to a table number 10, the table numbers 1 to 10 are registered in association with the store ID.

The server device 6 can identify a vacant seat in the store based on the slip information acquired from the store server 5 and the seat information management table 615 of a store. Specifically, the server device 6 recognizes a table number whose settlement completion flag is registered as “₀” in the slip information as acquired from the store server 5 of the store as a table number presently in use. Then, the server device 6 specifies a table number obtained by excluding the table number recognized as being in use from all table numbers corresponding to the store ID of the store in the seat information management table 615 as a table number of the vacant seat.

The mobile order server 3 can acquire, from the server device 6, vacant seat information indicating a vacant seat and output the obtained vacant seat information to the mobile terminal 2 of a mobile order service member. Accordingly, the member of the mobile order service can recognize a vacant seat status in the store without going to the store.

The mobile order server 3 can identify the vacant seats of the store by the above-described method by acquiring the slip information acquired from the store server 5 and the information in the seat information management table 615 of the store from the server device 6. In other words, processing for identifying a vacant seat of the store may be executed by the server device 6 or the mobile order server 3.

Returning to FIG. 7, the hardware configuration of the server device 6 will be described.

The display unit 62 is implemented as, for example, a liquid crystal panel, and displays various types of information. The display unit 62 displays information stored in, for example, the store master 612, the mobile order management table 613, the store-based slip information management table 614, and the seat information management table 615 as necessary.

The operation unit 63 is used for inputting information to the control unit 60. For example, the operation unit 63 is or includes a keyboard, a touch panel, a mouse, or the like.

The communication unit 64 is an interface for communicating with an external device such as the mobile terminal 2, the mobile order server 3, and the store server 5. The control unit 60 can transmit and receive information (data) to and from the external device by being connected to the external device via the communication unit 64.

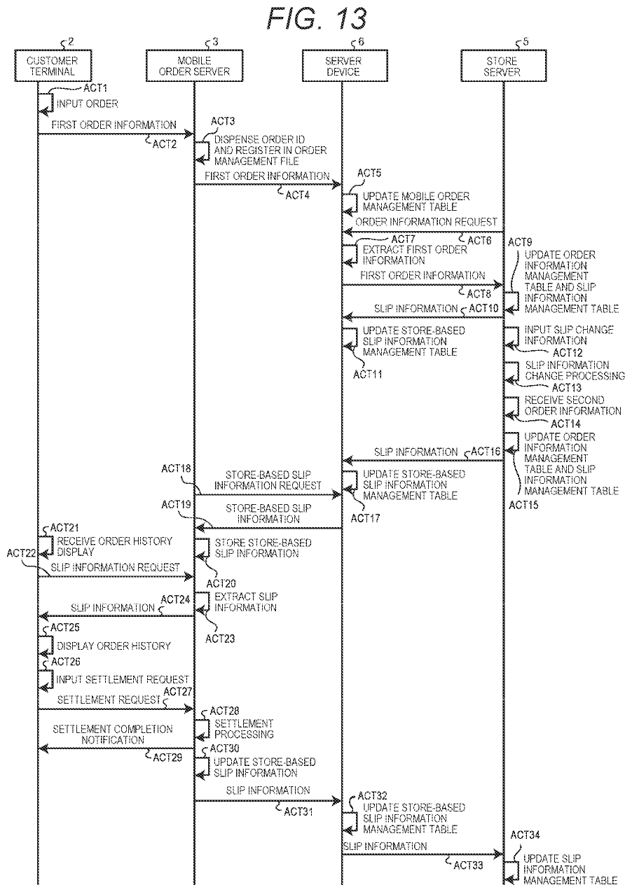

Next, a functional configuration of the server device 6 will be described. FIG. 12 is a block diagram showing a functional configuration of the control unit 60 of the server device 6. The control unit 60 functions as a transmission and reception unit 6001, an input unit 6002, an information management unit 6003, and a display control unit 6004 by the CPU 601 operating according to the control program stored in the ROM 602 and the storage unit 61. Each function may be implemented as hardware such as a dedicated circuit.

The transmission and reception unit 6001 transmits and receives various types of information to and from the mobile order server 3 and the store server 5. For example, the transmission and reception unit 6001 receives the first order information from the mobile order server 3. Further, the transmission and reception unit 6001 periodically receives the order information request for requesting the first order information from the store server 5, and transmits the corresponding first order information among the first order information acquired from the mobile order server 3 in response to a request to the store server 5. When the order system 1 does not include the mobile order server 3, the transmission and reception unit 6001 can transmit and receive information to and from the mobile terminal 2.

The transmission and reception unit 6001 receives the slip information from the store server 5. The slip information includes the third order information obtained by integrating the first order information and the second order information of the same customer. The transmission and reception unit 6001 functions as a first acquisition unit that acquires the first order information and a second acquisition unit that acquires the second order information in the information processing apparatus (server device 6).

The transmission and reception unit 6001 transmits the slip information including the third order information to the mobile order server 3. When the order system 1 does not include the mobile order server 3, the transmission and reception unit 6001 transmits the slip information to the mobile terminal 2. The transmission and reception unit 6001 functions as an output unit that outputs the third order information to the mobile order server 3 or the mobile terminal 2 of the customer.

Various types of information can be input to the input unit 6002 from the operation unit 63. For example, information for updating the store master 612 is input to the input unit 6002.

The information management unit 6003 manages the various types of information such as information received by the transmission and reception unit 6001. Here, the management of the information means writing or reading the various types of information (data) into or from the storage unit 61.

For example, the information management unit 6003 writes necessary information into the mobile order management table 613 based on the first order information received by the transmission and reception unit 6001. Specifically, the information management unit 6003 writes the order ID, the store ID, the table number, and the commodity ID included in the first order information received by the transmission and reception unit 6001 in the mobile order management table 613 in association with one another. At this time, the information management unit 6003 writes “0” to the corresponding transmission flag.

The information management unit 6003 reads the order information from the mobile order management table 613 based on the order information request received by the transmission and reception unit 6001. Specifically, when the transmission and reception unit 6001 receives the order information request, the information management unit 6003 reads, from the mobile order management table 613, the order information in which the store ID included in the order information request is registered and “0” is registered in the transmission flag.

The information management unit 6003 writes necessary information into the store-based slip information management table 614 based on the slip information received by the transmission and reception unit 6001. Specifically, when the transmission and reception unit 6001 receives the slip information and the store ID from the store server 5, the information management unit 6003 writes the slip information and the store ID in the store-based slip information management table 614 in association with each other.

The display control unit 6004 displays the various types of information on the display unit 62. For example, the display control unit 6004 displays the information stored in the store master 612, the mobile order management table 613, the store-based slip information management table 614, and the seat information management table 615 on the display unit 62 as necessary.

An outline of an operation of the order system 1 will be described. FIG. 13 is a sequence chart showing aspects of the operation of the order system 1. The sequence chart shows an operation flow when the customer who visits the store first orders a commodity by using the mobile terminal 2 and then additionally orders a commodity via the store clerk. Further, the sequence chart shows the operation flow when the customer performs settlement for all orders by the mobile order service.

The customer visits the store and sits at a table. The customer starts the mobile ordering application and places an order using the mobile terminal 2. Thus, an order is an input to the mobile terminal 2 (ACT 1). For example, the mobile terminal 2 first acquires a menu of the store, the store ID, the table number, and the like by reading a two-dimensional code provided at the table. The customer views the acquired menu or a menu posted in the store to input the order (the mobile order).

The mobile terminal 2 thus transmits first order information to the mobile order server 3 based on the input order (ACT 2). The first order information includes the member ID of the mobile order service, the store ID, the table number, and the commodity ID of the ordered commodity.

The mobile order server 3 dispenses an order ID for the received first order information, and registers the order ID and the received first order information in the order management file 32 in association with each other (ACT 3). The mobile order server 3 next transmits the first order information to the server device 6 (ACT 4). The first order information transmitted by the mobile order server 3 also includes the order ID as dispensed by the mobile order server 3.

The server device 6 registers the received first order information and updates the mobile order management table 613 (ACT 5). The store server 5 periodically transmits an order information request to the server device 6 (ACT 6). The order information request includes the store ID of the store that manages the store server 5.

The server device 6 extracts, from the mobile order management table 613, the first order information which corresponds to the store ID included in the received order information request but which has not yet been transmitted to the store server 5 (ACT 7). The server device 6 transmits the extracted first order information to the store server 5 (ACT 8). The server device 6 may transmit the first order information to the store server 5 each time the server device 6 receives the first order information from the mobile order server 3. In this case, the store server 5 does not need to transmit an order information request.

The store server 5 updates the order information management table 514 and the slip information management table 515 based on the received first order information (ACT 9). The store server 5 transmits update information for the slip information management table 515 to the server device 6 (ACT 10). The store server 5 may transmit only changed information or the updated slip information management table 515. Each time the slip information management table 515 is updated, the store server 5 transmits the updated information to the server device 6. The server device 6 updates the store-based slip information management table 614 based on the received slip information (ACT 11).

When slip change information is input (ACT 12), the store server 5 executes slip information change processing (ACT 13). The slip information change processing is processing of the slip information management table 515 based on information other than the order information. Details of the slip information change processing will be described below. The slip change information is information for updating the slip information management table 515 and is, for example, grouping information, table change information, and settlement information. The slip change information may be input to the store server 5 at any timing.

The grouping information is information indicating that one customer uses a plurality of tables and thus includes a plurality of table numbers. The table change information is information indicating that the customer moved to another table and includes the table number before the move and the table number after the move. The settlement information is information indicating that the customer completes the settlement of the ordered items, and includes the table number(s) and the ordered commodity IDs.

When the store clerk receives an order from the customer and the second order information is input to the order terminal 7, the store server 5 receives the second order information from the order terminal 7 (ACT 14). The second order information received by the store server 5 includes the table number and the commodity ID of the ordered commodity. The store server 5 updates the order information management table 514 and the slip information management table 515 based on the received second order information (ACT 15). Similarly to ACT 10, the store server 5 transmits the update information for the slip information management table 515 to the server device 6 (ACT 16). The server device 6 updates the store-based slip information management table 614 based on the received slip information (ACT 17).

The mobile order server 3 may periodically transmit a store-based slip information request to the server device 6 at a short time interval (ACT 18). The server device 6 transmits store-based slip information stored in the store-based slip information management table 614 to the mobile order server 3 as a response to the store-based slip information request (ACT 19).

The store-based slip information transmitted by the server device 6 is slip information for which the settlement is not completed, that is, slip information in which the settlement completion flag is “0” among the slip information stored in the store-based slip information management table 614. In other words, the store-based slip information transmitted by the server device 6 is slip information of the customer still seated at the table at that time. The mobile order server 3 stores the received store-based slip information in a storage unit (ACT 20). Accordingly, the mobile order server 3 can manage the second order information which is not yet settled.

The mobile order server 3 may transmit the slip information request to the server device 6 only when a slip information request is received from a mobile terminal 2. In other examples, the server device 6 may transmit the store-based slip information to the mobile order server 3 each time slip information is received from the store server 5. In this case, the mobile order server 3 does not need to transmit the slip information request.

When the customer confirms an order history (e.g., reviews the list of items ordered), an order history display can be shown by the mobile terminal 2 (ACT 21). The mobile terminal 2 transmits the slip information request to the mobile order server 3 (ACT 22). The slip information request includes a store ID and a table number. In some examples, the mobile terminal 2 may include the member ID in the slip information request instead of the table number. In this case, the mobile order server 3 refers to the order management file 32 and identifies the table number associated with the member ID included in the received slip information request.

The mobile order server 3 extracts the slip information including the store ID and the table number included in the received slip information request from the store-based slip information stored in the storage unit (ACT 23). The mobile order server 3 transmits the extracted slip information to the mobile terminal 2 which is a transmission source of the slip information request (ACT 24).

The mobile terminal 2 displays the order history based on the received slip information (ACT 25). A display format of the order history can be any format depending on the mobile order application provided in the mobile terminal 2. When the customer confirms the order history then makes a payment for settlement using the mobile order service, a settlement request is input to the mobile terminal 2 (ACT 26). The mobile terminal 2 transmits the settlement request to the mobile order server 3 (ACT 27). The settlement request includes the member ID and the slip number for which settlement is intended.

The mobile order server 3 executes settlement processing (ACT 28). The mobile order server 3 refers to the member master 31 and reads the settlement information of the member ID included in the settlement request. Then, the mobile order server 3 accesses the settlement server of the settlement provider and completes the settlement by using the read settlement information. When the settlement is completed, the mobile order server 3 transmits a settlement completion notification to the mobile terminal 2 (ACT 29).

The mobile order server 3 writes the settled information into the store-based slip information stored in the storage unit to update the corresponding slip information (ACT 30). The mobile order server 3 transmits the updated slip information to the server device 6 (ACT 31).

The server device 6 updates the store-based slip information management table 614 based on the received slip information (ACT 32). The server device 6 transmits the updated slip information to the store server 5 of the store that sold ordered commodity (ACT 33). The store server 5 updates the slip information management table 515 based on the received slip information (ACT 34).

With the operations described above, the mobile order server 3 can handle not only the first order information but also the second order information. Accordingly, the customer who is the member of the mobile order service can confirm the overall order history and perform settlement by using the mobile terminal 2 even for the second order information (in-store system ordering).

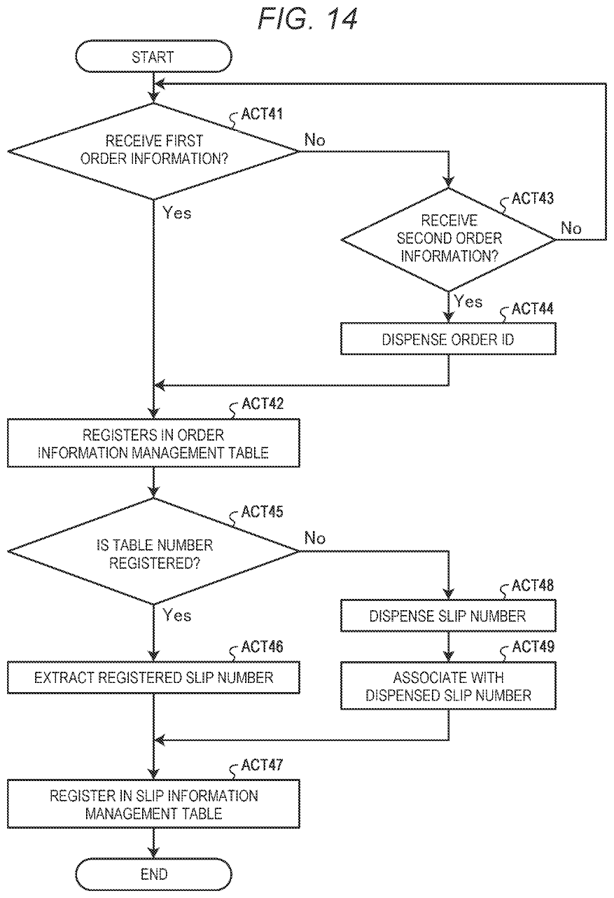

Next, order reception processing executed by the store server 5 will be described. FIG. 14 is a flowchart of the order reception processing by the control unit 50 of the store server 5.

The control unit 50 determines whether the transmission and reception unit 5001 has received first order information (ACT 41). If the transmission and reception unit 5001 received first order information (Y in ACT 41), the information management unit 5004 registers the first order information in the order information management table 514 (ACT 42).

If the transmission and reception unit 5001 does not receive first order information (N in ACT 41), the control unit 50 next determines whether the transmission and reception unit 5001 has received second order information (ACT 43). If the transmission and reception unit 5001 does not receive second order information (N in ACT 43), the control unit 50 returns to the processing of ACT 41. If the transmission and reception unit 5001 received second order information (Y in ACT 43), the information management unit 5004 dispenses the order ID (ACT 44). Then, the control unit 50 proceeds to the processing of ACT 42 to register the order information in the order information management table 514.

After the processing of ACT 42, the control unit 50 determines whether the table number included in the order information (the first order information or the second order information) received by the transmission and reception unit 5001 has already been registered in the slip information management table 515 (ACT 45). In other words, the control unit 50 determines whether the order information received by the transmission and reception unit 5001 is the order information related to the first order to be received from the customer.

If the table number included in the order information received by the transmission and reception unit 5001 is already registered in the slip information management table 515 (Y in ACT 45), the integrating unit 5003 extracts the slip number corresponding to the table number from the slip information management table 515 (ACT 46). The integrating unit 5003 registers the order information received by the transmission and reception unit 5001 in the slip information management table 515 in association with the extracted slip number (ACT 47). Then, the control unit 50 ends the order reception processing.

Accordingly, the slip information in which the plurality of pieces of order information are associated with one slip number is generated. As a result, the slip information is information obtained by integrating a plurality of pieces of order information. When the slip information includes both first order information and second order information, the slip information constitutes what is referred to as third order information.

In the processing of ACT 45, if the table number included in the order information received by the transmission and reception unit 5001 is not registered in the slip information management table 515 (N in ACT 45), the information management unit 5004 dispenses the slip number (ACT 48). The information management unit 5004 associates the order information received by the transmission and reception unit 5001 with the dispensed slip number (ACT 49). Then, the control unit 50 proceeds to the processing of ACT 47.

By the order reception processing, the store server 5 can receive both the first order information and the second order information. Further, the store server 5 can integrally manage the first order information and the second order information of the same customer.

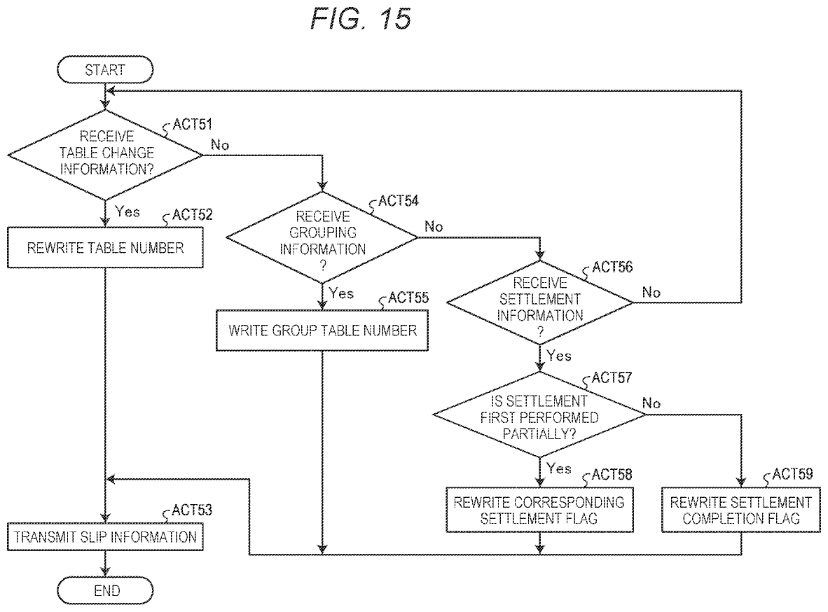

Next, the slip information change processing executed by the store server 5 will be described. FIG. 15 is a flowchart of slip information change processing by the control unit 50 of the store server 5.

The control unit 50 determines whether the transmission and reception unit 5001 has received table change information from the order terminal 7 (ACT 51). When the transmission and reception unit 5001 receives the table change information from the order terminal 7 (Y in ACT 51), the information management unit 5004 rewrites (updates) the table number in the slip information management table 515 (ACT 52). Specifically, the information management unit 5004 rewrites the table number after the movement of the customer included in the table change information to the table number of the slip information management table 515. The transmission and reception unit 5001 transmits the rewritten slip information to the server device 6 (ACT 53). Then, the control unit 50 ends the slip information change processing.

In the processing of ACT 51, if the transmission and reception unit 5001 does not receive table change information from the order terminal 7 (N in ACT 51), the control unit 50 next determines whether the transmission and reception unit 5001 received grouping information from the order terminal 7 (ACT 54). If the transmission and reception unit 5001 receives grouping information from the order terminal 7 (Y in ACT 54), the information management unit 5004 registers information in the group table number of the slip information management table 515 (ACT 55).

Specifically, the information management unit 5004 extracts the slip number corresponding to the table number registered in the slip information management table 515 among a plurality of table numbers included in the grouping information. Then, the information management unit 5004 registers another table number included in the grouping information in the group table number corresponding to the extracted slip number. When none of the plurality of table numbers included in the grouping information has been registered in the slip information management table 515, the information management unit 5004 newly dispenses a slip number and registers the newly dispensed slip number in the slip information management table 515. Then, the information management unit 5004 registers any one of the plurality of table numbers included in the grouping information in the table number corresponding to the newly dispensed slip number. Further, the information management unit 5004 registers the other table numbers included in the grouping information in the group table number corresponding to the newly dispensed slip number. Then, the control unit 50 proceeds to the processing of ACT 53.

In the processing of ACT 54, if the transmission and reception unit 5001 does not receive grouping information from the order terminal 7 (N in ACT 54), the control unit 50 next determines whether the transmission and reception unit 5001 has received settlement information from the POS terminal 9 (ACT 56). If the transmission and reception unit 5001 does not receive settlement information from the POS terminal 9 (N in ACT 56), the control unit 50 returns to the processing of ACT 51.

If the transmission and reception unit 5001 received settlement information from the POS terminal 9 (Y in ACT 56), the control unit 50 next determines whether the settlement information is settlement information in which the settlement is being performed partially (ACT 57). The control unit 50 compares the commodity IDs included in the settlement information with the commodity IDs corresponding to the table number included in the settlement information in the slip information management table 515. If the commodity IDs included in the settlement information are not all the commodity IDs registered as corresponding to the table number, the control unit 50 determines that the settlement information is the settlement information in which the settlement is to be first performed partially.

If the settlement information is for a partial settlement (Y in ACT 57), the information management unit 5004 rewrites the settlement flag corresponding to those commodity IDs included in the settlement information to “1” (ACT 58). When the settlement flags of all the commodity IDs corresponding to the same slip number have been rewritten to “1”, the information management unit 5004 rewrites the settlement completion flag to “1” at the same time. Then, the control unit 50 proceeds to the processing of ACT 53.

If the settlement information is not for a partial settlement (N in ACT 57), that is, settlement is for all of the ordered commodities, the information management unit 5004 rewrites the settlement completion flag corresponding to the table number to “1” (ACT 59). At this time, the information management unit 5004 may rewrite the settlement flags of all the commodity IDs corresponding to the table number included in the settlement information to “1”. Then, the control unit 50 proceeds to the processing of ACT 53.

By the slip information change processing, the store server 5 can appropriately execute a change in the necessary slip information and transmit the changed slip information to the mobile order server 3 via the server device 6. Accordingly, the mobile order server 3 can provide the latest slip information to the mobile terminal 2.

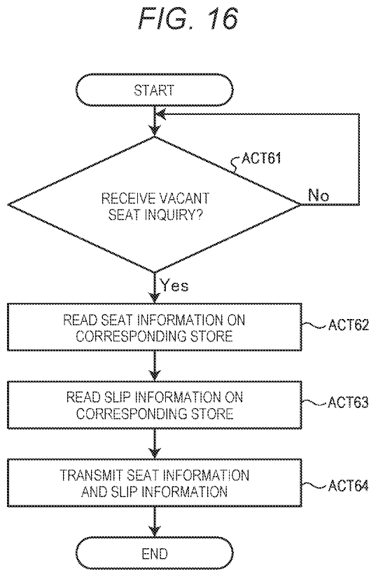

Next, vacant seat notification processing executed by the server device 6 will be described. FIG. 16 is a flowchart of the vacant seat notification processing by the control unit 60 of the server device 6.

The control unit 60 determines whether the transmission and reception unit 6001 has received a vacant seat inquiry from the mobile order server 3 (ACT 61), and returns to the processing of ACT 61 and stands by if the transmission and reception unit 6001 has not received the vacant seat inquiry (N in ACT 61). The vacant seat inquiry includes a store ID.

If the transmission and reception unit 6001 receives the vacant seat inquiry from the mobile order server 3 (Y in ACT 61), the information management unit 6003 reads the seat information corresponding to the store ID included in the vacant seat inquiry from the seat information management table 615 (ACT 62). Next, the information management unit 6003 reads the slip information corresponding to the store ID from the store-based slip information management table 614 (ACT 63).

The transmission and reception unit 6001 transmits the seat information and the slip information to the mobile order server 3 (ACT 64). Then, the control unit 60 ends the vacant seat notification processing.

By the vacant seat notification processing, the server device 6 can provide the mobile order server 3 with information necessary for the mobile order server 3 to identify the vacant seats (tables) in the store. By the mobile order server 3 transmitting the vacant seat information to the mobile terminal 2, the customer can recognize the vacant seat status of a store. The vacant seat information transmitted from the mobile order server 3 to the mobile terminal 2 indicates the vacant seat status of the store and includes, for example, the store name and an unused table number. The identification of the vacant seat in the store may be performed by the server device 6. In this case, the store server 5 transmits the vacant seat information to the mobile order server 3.

As described above, the server device 6 according to the embodiment includes a first acquisition unit (the transmission and reception unit 6001) configured to acquire first order information including a commodity ID for specifying an ordered commodity, the first order information being order information received by the mobile order server 3 having a settlement function from the mobile terminal 2 of a customer, a second acquisition unit (the transmission and reception unit 6001) configured to acquire second order information including a commodity ID for specifying an ordered commodity, the second order information being order information received by the order terminal 7 of a store that sells the commodity, and an output unit (the transmission and reception unit 6001) configured to output third order information to the mobile order server 3 or the mobile terminal 2 of the customer, the third order information being obtained by integrating the first order information and the second order information of the same customer.

Accordingly, the server device 6 can associate the third order information obtained by integrating the first order information and the second order information of the same customer with a mobile order service. Therefore, the customer who uses the mobile order service can confirm an order history and perform settlement by using the mobile terminal 2 based on not only just the first order information but also the second order information. Accordingly, the server device 6 can improve convenience of the customer who uses the mobile order service.

Further, in the server device 6 according to the embodiment, the first order information includes the store ID for specifying a store that sells an ordered commodity, and the output unit outputs the first order information acquired by the first acquisition unit to the store server 5 configured to manage an order of the store specified based on store specifying information included in the first order information.

Accordingly, the server device 6 can input the first order information to the store server 5. Therefore, the store does not need to input the first order information to the store server 5, and efficiency of an order receiving work can be improved and an error in inputting order information can be prevented.

The order management system 4 according to the embodiment is the order management system 4 including: the store server 5 configured to manage information about a store that sells a commodity; the server device 6 communicably connected to the store server 5; a first acquisition unit (the transmission and reception unit 5001) configured to acquire first order information including a commodity ID for specifying an ordered commodity, the first order information being order information received by the mobile order server 3 having a settlement function from the mobile terminal 2 of a customer; a second acquisition unit (transmission and reception unit 5001) configured to acquire second order information including a commodity ID for specifying an ordered commodity, the second order information being order information received by the order terminal 7 of the store; the integration unit 5003 configured to integrate the first order information and the second order information of the same customer; and an output unit (transmission and reception unit 6001) configured to output third order information integrated by the integration unit 5003 to the mobile order server 3 or the mobile terminal 2 of the customer.

Accordingly, the order management system 4 can associate the third order information obtained by integrating the first order information and the second order information of the same customer with the mobile order service. Therefore, the customer who uses the mobile order service can confirm an order history and perform settlement by using the mobile terminal 2 of the customer based on not only the first order information but also the second order information. Accordingly, the order management system 4 can improve convenience for the customer who uses the mobile order service.

In the order management system 4 according to the embodiment, the first order information and the second order information include customer specifying information for specifying the customer, and the integration unit 5003 associates the first order information and the second order information with the customer specifying information.

Accordingly, the order management system 4 can associate the first order information and the second order information of the same customer. Therefore, a provider of the mobile order service does not need to perform the association, and management of the order information becomes easy.

In the order management system 4 according to the embodiment, the customer specifying information is a table number for specifying a seat on which the customer is seated in the store, and the order management system 4 further includes a seat information acquisition unit (transmission and reception unit 5001) configured to acquire seat information for specifying a changed seat when the customer changes a seat.

Accordingly, when the store receives the order, the order management system 4 can associate the first order information and the second order information of the same customer with each other by using the table number of the customer. Therefore, there is no need to newly set data for associating the first order information with the second order information, and the first order information can be easily associated with the second order information. Further, the order management system 4 can manage the order information for each customer even when the customer moves to another seat.

In addition, the order management system 4 according to the embodiment further includes a settlement information acquisition unit (transmission and reception unit 5001) configured to acquire settlement information indicating a settlement status of the third order information, and an information management unit 5004 configured to manage the settlement information acquired by the settlement information acquisition unit in association with the third order information.

Accordingly, the order management system 4 can associate the order information including the settlement status with the mobile order service. Therefore, the customer can also recognize, for example, settlement information in which a part of commodities in the order information is paid at the store. Accordingly, the order management system 4 can contribute to improvement of a service for a member of the mobile order service.

In the embodiment described above, the control program executed by each of the mobile terminal 2, the store server 5, and the server device 6 may be provided by being recorded in a non-transitory, computer-readable recording medium such as a CD-ROM. In addition, the control program executed by each device according to an embodiment described above may be stored in a computer connected to a network such as the Internet, may be provided by being downloaded via the network, or may be accessed via the network such as the Internet.

While the embodiment described herein has been explained above, the embodiment has been presented by way of example only, and is not intended to limit the scope of the exemplary embodiment. The embodiment can be implemented in various other forms, and various omissions, substitutions, and changes can be made without departing from the gist of the disclosure.

What is claimed is:

1. An information processing apparatus, comprising:
a communication interface connectable to a mobile ordering server and a store ordering server; and
a control unit configured to:
acquire, via the communication interface, first order information from the mobile ordering server, the first order information including information about items ordered by a customer from a store via a mobile ordering application on a mobile terminal of the customer;
acquire second order information, via the communication interface, from the store ordering server of the store, the second order information including information about items ordered by the customer from the store via an in-store ordering system of the store; and
output third order information to the mobile ordering server or the mobile terminal of the customer, the third order information being obtained by combining the first order information and the second order information.

2. The information processing apparatus according to claim 1, wherein
the first order information includes a store ID of the store, and
the control unit is further configured to output, via the communication interface, the first order information to the store ordering server.

3. The information processing apparatus according to claim 1, further comprising:
a storage unit, wherein
the first order information is stored in the storage unit in association with a table number and a store ID,
the second order includes the table number and the store ID, and
the first and second order information is combined based on the table number and store ID.

4. The information processing apparatus according to claim 1, wherein the third order information is output to the mobile ordering server.

5. The information processing apparatus according to claim 4, wherein transaction settlement is performed by the mobile ordering server based on the third order information.

6. The information processing apparatus according to claim 1, wherein the third order information is output to the store ordering server after being output to the mobile terminal for confirmation by the customer.

7. The information processing apparatus according to claim 1, wherein the third order information is output to the mobile terminal.

8. The information processing apparatus according to claim 1, wherein the control unit is further configured to receive, via the communication interface, from the mobile terminal a selection of items in the third order information to be paid for by settlement performed via the mobile ordering server.

9. The information processing apparatus according to claim 8, wherein the control unit is further configured to set a settlement flag for any items in the third order information paid for by the settlement performed via the mobile ordering server.

10. The information processing apparatus according to claim 1, wherein the control unit is further configured to receive, via the communication interface, a table status request from the mobile device and output a table status response indicating an available table at the store determined based on open ordering slips and a table list for the store.

11. An order management system, comprising:
a plurality of store ordering servers configured to manage in-store order information for individual stores in a plurality of stores;
a mobile ordering server configured to manage mobile order information received from mobile terminals for the plurality of stores; and
a server device connected to the plurality of store ordering servers and the mobile ordering server via a network, the server device including:
a communication interface connectable the network; and
a control unit configured to:
acquire, via the communication interface, first order information from the mobile ordering server, the first order information including information about items ordered by a customer from a store in the plurality of stores via a mobile ordering application on a mobile terminal of the customer;
acquire second order information, via the communication interface, from the store ordering server of the store, the second order information including information about items ordered by the customer from the store via an in-store ordering system of the store; and
output third order information to the mobile ordering server or the mobile terminal of the customer, the third order information being obtained by combining the first order information and the second order information.

12. The order management system according to claim 11, wherein
the first order information includes a store ID of the store, and
the control unit is further configured to output, via the communication interface, the first order information to the store ordering server of the store.

13. The order management system according to claim 11, wherein
the first order information is stored in a storage unit in association with a table number and a store ID of the store,
the second order includes the table number and the store ID, and
the first and second order information is combined based on the table number and store ID.

14. The order management system according to claim 11, wherein the third order information is output to the mobile ordering server.

15. The order management system according to claim 14, wherein transaction settlement is performed by the mobile ordering server based on the third order information.

16. The order management system according to claim 11, wherein the third order information is output to the store ordering server after being output to the mobile terminal for confirmation by the customer.

17. The order management system according to claim 11, wherein the third order information is output to the mobile terminal.

18. The order management system according to claim 11, wherein the control unit is further configured to receive, via the communication interface, from the mobile terminal a selection of items in the third order information to be paid for by settlement performed via the mobile ordering server.

19. The order management system according to claim 18, wherein the control unit is further configured to set a settlement flag for any items in the third order information paid for by the settlement performed via the mobile ordering server.

20. The order management system according to claim 11, wherein the control unit is further configured to receive, via the communication interface, a table status request from the mobile device and output a table status response indicating an available table at the store determined based on open ordering slips and a table list for the store.
